(19) United States
(12) Patent Application Publication
(10) Pub. No.: US 2026/0094313 A1
(43) Pub. Date: Apr. 2, 2026

(54) INFORMATION PROCESSING DEVICE, INFORMATION PROCESSING SYSTEM, AND INFORMATION PROCESSING METHOD

(71) Applicant: HONDA MOTOR CO., LTD., Tokyo (JP)

(72) Inventors: Yusuke Ishida, Tokyo (JP); Yuta Nishizawa, Tokyo (JP); Kenta Maruyama, Tokyo (JP)

(21) Appl. No.: 19/332,093

(22) Filed: Sep. 18, 2025

(30) Foreign Application Priority Data
Sep. 30, 2024 (JP) 2024-169969

(51) Int. Cl. G06T 11/00; G06F 3/01; G06T 5/92

(52) U.S. Cl. CPC G06T 11/00; G06F 3/013; G06T 5/92; G06T 2207/30252

(57) ABSTRACT

An information processing device processes information provided for a second device, which is used at a place different from that of a mobile object by a user, from a first device mounted in the mobile object. The information processing device includes an acquisition part, a provision part, a reception part, and a brightness modification part. The acquisition part obtains information including moving image data transmitted by the first device. The provision part provides moving image data for the second device based on the information obtained by the acquisition part. The reception part accepts a first operation performed for a partial area of a moving image presented to the user based on the moving image data provided for the second device by the provision part. The brightness modification part changes brightness of the partial area of the moving image based on the first operation accepted by the reception part.

### CROSS-REFERENCE TO RELATED APPLICATION

Priority is claimed on Japanese Patent Application No. 2024-169969, filed September 30, 2024, the content of which is incorporated herein by reference.

### BACKGROUND OF THE INVENTION

### Field of the Invention

The present invention relates to an information processing device, an information processing system, and an information processing method.

### Description of Related Art

In recent years, countermeasures to provide access to sustainable transportation systems that take into consideration vulnerable people among traffic participants such as the elderly, people with disabilities, and children as well have been active. To achieve this, emphasis is being placed on research and development aimed at further improving the safety and convenience of transportation, especially through the development of moving means dedicated for transportation-disadvantaged individuals.

In relation to this, a technology that can automatically adjust the brightness of a projected video in accordance with the brightness of the surroundings is known (see, for example, Patent Document 1 (Japanese Patent Laid-Open Publication No. 2005-321535)).

Meanwhile, in a case in which a simulated experience of riding in a mobile object (hereinafter referred to as "simulated ride") using a device located at a place different from that of the mobile object is performed, there is a problem in that the user who undergoes the simulated ride at a place different from that of the mobile object bears a significant burden.

### SUMMARY OF THE INVENTION

An object of the present application is to enable a user present at a place different from that of a mobile object to undergo a more appropriate simulated ride. Furthermore, this contributes to the development of a sustainable transportation system and supports strong connectivity between urban areas and rural areas starting from suburban areas.

An information processing device, an information processing system, and an information processing method according to the present invention employ the following configurations.

(1): According to one aspect of the present invention, there is provided an information processing device that processes information provided for a second device, which is used at a place different from that of a mobile object by a user, from a first device mounted in the mobile object, the information processing device including: an acquisition part configured to obtain information including moving image data transmitted by the first device; a provision part configured to provide moving image data for the second device based on the information obtained by the acquisition part; a reception part configured to accept a first operation performed for a partial area of a moving image presented to the user based on the moving image data provided for the second device by the provision part; and a brightness modification part configured to change brightness of the partial area of the moving image based on the first operation accepted by the reception part.

(2): In the aspect (1) described above, the first device may include an imaging device, and the brightness modification part may generate control information for causing the imaging device to change the brightness based on the first operation accepted by the reception part.

(3): In the aspect (1) described above, the reception part may notify the mobile object that a first operation changing the brightness has been performed based on the accepted first operation.

(4): In the aspect (2) described above, the imaging device may perform brightness adjustment of the partial area based on brightness of the surroundings.

(5): In the aspect (1) described above, a detection part configured to detect a gaze area at which the user of the moving image is gazing may be further included, and the brightness modification part may change brightness of the gaze area on the moving image based on the gaze area detected by the detection part.

(6): In the aspect (1) described above, an audio recognition part configured to detect an audio and perform speech recognition may be further included, and the brightness modification part may adjust brightness of relating POI information in a case in which an audio recognized by the audio recognition part relates to Point of Interest (POI) information of the surroundings of the mobile object.

(7): In the aspect (1) described above, a detection part configured to detect a gaze area at which the user of the moving image is gazing may be further included, the reception part may accept a second operation in a case in which the detection part detects that a partial area of the moving image has been gazed at for a predetermined time or more, and the brightness modification part may change brightness of the partial area of the moving image based on the second operation accepted by the reception part.

(8): In the aspect (7) described above, the second operation may include a blink, a gesture, and speech.

(9): In the aspect (7) described above, the number of actions included in the second operation may be larger than the number of actions included in the first operation.

(10): In the aspect (1) described above, the brightness modification part may give priority for brightness adjustment to the second device that has been connected to the information processing device first among a plurality of second devices.

(11): In the aspect (1) described above, in a case in which the first operations from a plurality of second devices accepted by the reception part contend with each other, the brightness modification part may notify the plurality of second devices contending with each other of the contention.

(12): In the aspect (1) described above, in a case in which the first operations from a plurality of second devices contend with each other, the brightness modification part may perform a process of detecting POI information of the surroundings of a partial area of the moving image for which the first operation has been performed by a user of each of the plurality of second devices contending with each other and, in a case in which the POI information has been able to be detected, adjust brightness of an area in which the POI information has been detected or the POI information.

(13): In the aspect (1) described above, in a case in which the first operations from a plurality of second devices accepted by the reception part contend with each other, the brightness modification part may perform a process of detecting POI information of the surroundings of a partial area of the moving image for which the first operation has been performed by a user of each of the plurality of second devices contending with each other and, in a case in which a plurality of pieces of the POI information have been able to be detected, notify the user of each of the plurality of second devices, of which the first operations contend with each other, of an overview of the plurality of pieces of the POI information.

(14): According to one aspect of the present invention, there is provided an information processing system including: a first device configured to be mounted in a mobile object; a second device used at a place different from that of the mobile object by a user; an acquisition part configured to obtain information including moving image data transmitted by the first device; a provision part configured to provide moving image data for the second device based on the information obtained by the acquisition part; a reception part configured to accept a first operation performed for a partial area of a moving image presented to the user based on the moving image data provided for the second device by the provision part; and a brightness modification part configured to change brightness of the partial area of the moving image based on the first operation accepted by the reception part.

(15): According to one aspect of the present invention, there is provided an information processing method using an information processing device that processes information provided for a second device, which is used at a place different from that of a mobile object by a user, from a first device mounted in the mobile object, the information processing method including: obtaining information including moving image data transmitted by the first device; providing moving image data for the second device based on the obtained information; accepting a first operation performed for a partial area of a moving image presented to the user based on the moving image data provided for the second device; and changing brightness of the partial area of the moving image based on the accepted first operation.

According to the aspects (1) to (15) described above, a user present at a place different from that of a mobile object is able to undergo a more appropriate simulated ride.

### BRIEF DESCRIPTION OF THE DRAWINGS

FIG. 1 is a diagram showing usage environments and the like of an information processing system 1 and a management server 300.

FIG. 2 is a diagram showing an example of details of user data 360.

FIG. 3 is a configuration diagram of a first device 100.

FIG. 4 is a diagram showing an arrangement example of a part of the first device 100 in a mobile object M.

FIG. 5 is a configuration diagram of a second device 200.

FIG. 6 is a diagram showing an image corresponding to an orientation direction.

FIG. 7 is a diagram showing a first example of the functional configuration of a first controller 170 and a second controller 270.

FIG. 8 is a diagram showing a second example of the functional configuration of the first controller 170 and the second controller 270.

FIG. 9 is a sequence diagram showing an example of a process executed by the information processing system 1.

FIG. 10 is a diagram showing an example of image IM10 representing inquiry information.

FIG. 11 is a diagram showing an example of image IM20 representing a request result.

FIG. 12A is a sequence diagram showing a first example of a process executed by the information processing system 1.

FIG. 12B is a sequence diagram showing a second example of a process executed by the information processing system 1.

FIG. 12C is a sequence diagram showing a third example of a process executed by the information processing system 1.

FIG. 12D is a sequence diagram showing a fourth example of a process executed by the information processing system 1.

FIG. 13 is a diagram showing an example of provided information.

### DETAILED DESCRIPTION OF THE INVENTION

Hereinafter, an information processing device, an information processing system, and an information processing method according to an embodiment of the present invention are described with reference to the drawings. Hereinafter, an information processing system to which an information processing device is applied is described. The information processing system, for example, includes a first device mounted in a mobile object in which a passenger rides, a second device used by a user at a place different from that of the mobile object, and an information processing device. Although the mobile object, for example, is a vehicle, it may be any mobile object (for example, a ship or a flying object) as long as a passenger can ride therein. Although the passenger is mainly a driver of a mobile object, the passenger may be a passenger other than the driver.

Between the first device and the second device, an audio collected by a microphone is transmitted to an opponent side and is reproduced by a speaker, whereby a state in which a phone call being conducted is formed. Furthermore, a part of an image captured by a camera unit of the first device is displayed by the second device, whereby mixed reality (MR) is provided for the second device side. In accordance with this, a user of the second device can have a feeling as if the user were riding on a mobile object in a simulated manner (simulated riding experience) while the user is present at a place different from that of the mobile object. A passenger can have a feeling as if a user were also actually riding in a mobile object by talking with the user having a simulated riding experience for the mobile object through the first device. In accordance with a part of an image captured by the camera unit of the first device being displayed by the second device, virtual reality (VR) may be provided for the second device side. In accordance with this, a user of the second device can have a feeling as if the user is riding in a mobile object in a simulated manner (simulated riding experience) while being present at a place different from that of the mobile object, and a passenger can have a feeling as if the user is actually riding together in the mobile object by talking with the user having simulated riding experience for the mobile object through the first device. Furthermore, a user can fully immerse himself or herself in the world of the video while using the application. Hereinafter, as described above, a user having a simulated experience as if the user is actually riding in the mobile object may be referred to as “simulated riding”. It is not necessary for the first device and the second device to have a one-to-one relationship, and one of a plurality of first devices and a plurality of second devices may be matched with a one-to-many relationship so as to operate as an information processing system. In such a case, for example, a single passenger can communicate with a plurality of users either simultaneously or sequentially.

### Basic Configuration

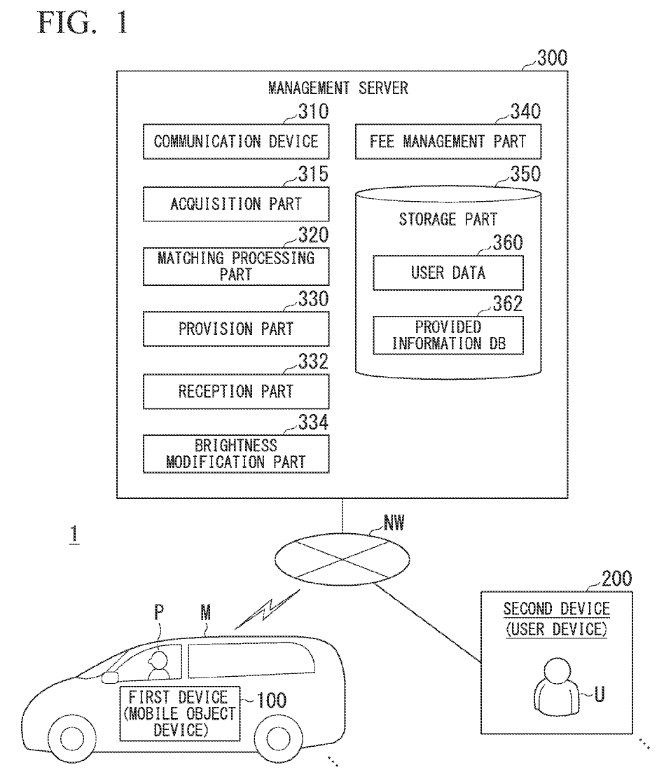

FIG. 1 is a diagram showing usage environments and the like of an information processing system 1 and a management server 300. The information processing system 1 includes a first device (a mobile object device) 100 mounted in a mobile object M in which a passenger P is riding and a second device (a user device) 200 used by a user U at a place different from that of the mobile object M (the case of the place happening to be a nearby place is not excluded). The first device 100, the second device 200, and a management server 300 communicate with each other through a network NW. The information processing system 1 may or may not include the management server 300.

The network NW, for example, may include at least one of the Internet, a wide area network (WAN), a local area network (LAN), a mobile communication network, a cellular network and the like. The management server 300 is one example of “information processing device”. In addition, the management server 300 may be implemented in a server apparatus or a storage device built into a cloud computing system. In such a case, the function of the management server 300 may be realized by a plurality of server apparatuses or storage devices in the cloud computing system. The first device 100 mounted in the mobile object M may be realized by a plurality of units.

The management server 300 manages information provided for each of the first device 100 and the second device 200 or performs management for communication thereof. The management server 300, for example, includes a communication device 310, an acquisition part 315, a matching processing part 320, a provision part 330, a reception part 332, a brightness modification part 334, a fee management part 340, and a storage part 350. The acquisition part 315, the matching processing part 320, the provision part 330, the reception part 332, the brightness modification part 334, and the fee management part 340, for example, are realized by a hardware processor such as a central processing unit (CPU) or the like executing a program (software).

Some or all of such constituent elements may be realized by hardware (a circuit part; includes circuitry) such as a large scale integration (LSI), an application specific integrated circuit (ASIC), a field-programmable gate array (FPGA), a graphics processing unit (GPU), or the like and may be realized by software and hardware in cooperation. The program may be stored in a storage device such as a hard disk drive (HDD) or a flash memory (a storage device including a non-transitory storage medium) in advance or may be stored in a storage medium (a non-transitory storage medium) that can be loaded or unloaded such as DVD or a CD-ROM and installed by loading the storage medium into a drive device. The program may be stored in the management server 300 and be appropriately updated through connection to a network NW.

The communication device 310 is a communication interface that is used for connection to a network NW. In addition, the communication between the communication device 310 and the first device 100 and the communication between the communication device 310 and the second device 200, for example, are performed in accordance with a transmission control protocol/Internet protocol (TCP/IP).

The acquisition part 315 obtains various kinds of information transmitted by the first device 100, the second device 200, and other external devices through a network NW. The various kinds of information may include moving image data, audio data of a driver, and vehicle data (display details of meter and an in-vehicle infotainment (IVI) system and the like).

The matching processing part 320, for example, is realized by a processor such as a CPU executing a program (a set of instructions) stored in a storage medium. For example, in a case in which a matching request is received from a user U through the second device 200 or from a passenger P through the first device 100 by the communication device 310, the matching processing part 320 performs matching between a matching user U and a passenger P by referring to user data 360. In addition, the matching processing part 320, by using the communication device 310, transmits communication identifying information of the first device 100 of the passenger P to the second device 200 of the matched user U and transmits communication identifying information of the second device 200 of the user U to the first device 100 of the matched passenger P. Between the first device 100 and the second device 200 that have received these, for example, communication having higher real-time performance according to the user datagram protocol (UDP) can be executed.

The provision part 330 generates information provided for each of the first device 100 and the second device 200 based on various kinds of information obtained by the acquisition part 315 and transmits the generated information to a target device. The provision part 330 generates information representing a process result acquired by the matching processing part 320, fee information (settlement information) managed by the fee management part 340, and the like and provides the generated information for a target device.

The reception part 332 receives first operation information and second operation information transmitted from the second device 200. The first operation information and the second operation information are performed for a partial area of a moving image presented to a user U based on moving image data provided for the second device 200 by the provision part 330. In addition, the reception part 332 receives text information transmitted from the second device 200. The reception part 332 receives information representing a gaze area transmitted from the second device 200.

The brightness modification part 334 changes the brightness of a partial area of a moving image based on first operation information received by the reception part 332. For example, the brightness modification part 334 generates control information for changing the brightness using a camera imaging a partial area of a moving image among cameras included in a camera unit 130 based on the first operation information. The brightness modification part 334 changes the brightness of a partial area of a moving image based on second operation information received by the reception part 332. For example, the brightness modification part 334 generates control information for changing the brightness using a camera imaging a gaze area at which a user U is gazing for a predetermined time or more among cameras included in the camera unit 130 based on the second operation information.

The brightness modification part 334 judges whether or not point of interest (POI) information relating to text information is included in POI information registered in a provided information DB 362 stored in the storage part 350 based on the text information received by the reception part 332. In a case in which POI information relating to text information is included in the POI information registered in the provided information DB 362, the brightness modification part 334 identifies a camera imaging the related POI information from information (moving image data) provided for the second device 200 by the provision part 330 among the cameras included in the camera unit 130 and generates control information for changing the brightness in the identified camera.

The brightness modification part 334 changes the brightness of a gaze area of a moving image based on information representing the gaze area received by the reception part 332. For example, the brightness modification part 334 generates control information for changing the brightness in a camera imaging a gaze area at which a user U is gazing among cameras included in the camera unit 130 based on information representing the gaze area.

The brightness modification part 334 transmits the generated control information to the first device 100.

The fee management part 340 manages a fee billed to a user U in accordance with information provided for the user U and a fee billed to a passenger P in accordance with information provided for the passenger P of the mobile object M. The fee management part 340, for example, may manage compensation to be paid to a user U and a passenger P in accordance with the provision of information from the user U and the passenger P. The fee management part 340 may perform a process relating to settlement of the user U and the passenger P.

The storage part 350 may be realized by various kinds of storage devices described above, or a solid-state drive (SSD), an electrically erasable programmable read only memory (EEPROM), a read only memory (ROM), or a random access memory (RAM), and the like. In the storage part 350, for example, the user data 360, the provided information DB 362, programs, and other various kinds of information can be stored.

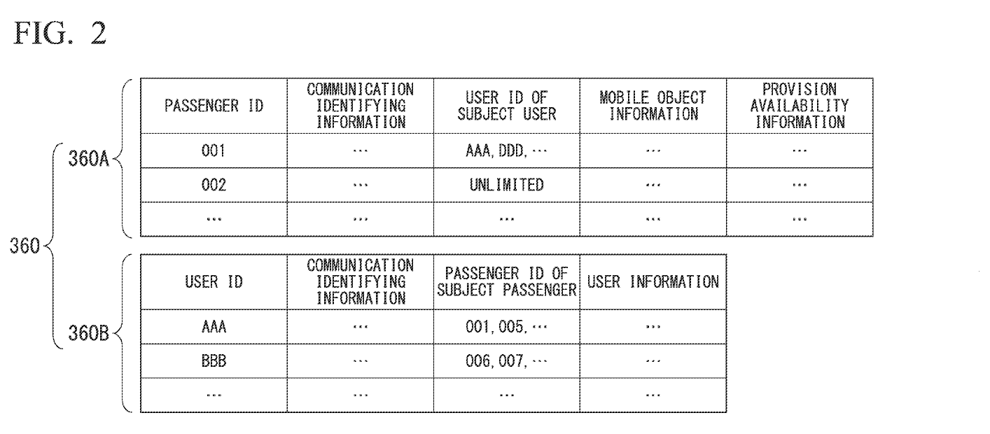

FIG. 2 is a diagram showing an example of details of the user data 360. The user data 360 includes a passenger list 360A and a user list 360B. In the passenger list 360A, for example, a passenger ID that is identification information of a passenger P of the mobile object M, communication identifying information thereof (an IP address or the like), a user ID that is identification information of a user U who is a matching target, mobile object information about a mobile object in which a passenger is riding, and provision availability information set by the passenger are associated with each other. The mobile object information, for example, includes device information mounted in the mobile object M (mounted device information) and vehicle class information representing the size and the external shape of the mobile object M. The mobile object information may include a current position and a destination of the mobile object M and information about the surrounding conditions of the mobile object M (for example, traveling along a coastal road) that are transmitted from the mobile object M at predetermined intervals.

In the user list 360B, for example, a user ID, communication identifying information thereof (an IP address or the like), a passenger P who is a matching target, and user information are associated with each other. The user information may include information relating to physique (for example, a height or a sitting height), information that can be used to estimate physique (for example, the age), and the like. The provision availability information is information that can be provided by the mobile object M or information that cannot be provided and, for example, is set by the passenger P. The provision availability information may be set for each mounting device of the mobile object M or may be set for each user U. As examples of the provision availability information, for example, there are “Provision of an image is permitted”, “Provision of audio is not permitted”, “Although provision of an indoor image is permitted, provision of an outdoor image is not permitted”, “Provision of an image of a passenger is not permitted”, “The use of a navigation device is not permitted”, and the like, but the information is not limited thereto. The provision availability information may include a fee enabling provision (service provision fee). The user data 360 is not limited to the form shown in FIG. 2 as long as it includes such information and may be generated in any form.

In the provided information DB 362, various kinds of information provided for a user U or a passenger P is stored. The various kinds of information, for example, include map information, point of interest (POI) information, images drawn through computer processing (for example, computer graphics (CG) images of persons and the like, images of marks, symbols, icons, and the like) and the like. The POI information, for example, is information relating to various stores, theme parks, landmarks, and the like for each location and may be included in the map information. The various kinds of information may include audio information. The provided information DB 362 may include advertisement information. The advertisement information may include, for example, an advertisement relating to a mobile object M, an advertisement relating to a user U or a passenger P, and other advertisements relating to a product or a service of a store. The inserted advertisement information may be managed separately from indoor/outdoor information and the like, and when is being archived and distributed later, the information may differ from inserted advertisement information at the time of real-time distribution (for example, a closed store may be replaced with a new one, or the introduced menu may be updated to the latest version, or the like). The advertisement information, for example, may be a moving image or audio.

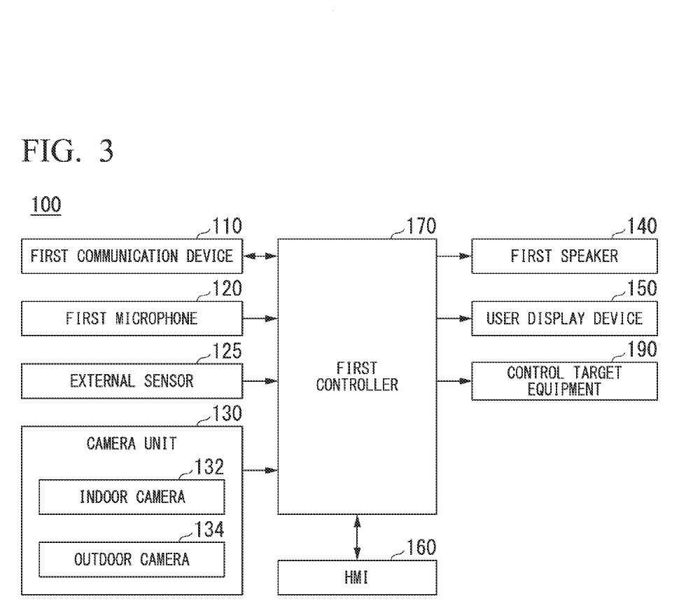

FIG. 3 is a configuration diagram of the first device 100. The first device 100, for example, includes a first communication device 110, a first microphone 120, an external sensor 125, a camera unit 130, a first speaker 140, a user display device 150, a human machine interface (HMI) 160, and a first controller 170. The first controller 170 is connected to a control target equipment 190 mounted in the mobile object M.

The first communication device 110 is a communication interface used for communicating with each of the communication device 310 of the management server 300 and a second communication device 210 of the second device 200 to be described below through a network NW.

The first microphone 120 collects audio produced at least by the passenger P. The first microphone 120 is disposed in an indoor space of the mobile object M and may have a sensitivity also enabling collection of external audio of the mobile object M. The first microphone 120 may include a microphone disposed in an indoor space of the mobile object M and a microphone disposed outside of the mobile object M. Hereinafter, audio information obtained by a microphone disposed in an indoor space may be referred to as “indoor audio information”. The audio collected by the first microphone 120, for example, is transmitted to the management server 300 or the second device 200 by the first communication device 110 via the first controller 170. In a case in which a microphone disposed outside of the mobile object M cannot be set, outdoor audio information may be pseudo-generated by processing indoor audio information based on traveling information (such a vehicle speed, acceleration/deceleration, road surface vibrations, and the like) and the surrounding traveling environment. The positional relation of a speaker with respect to the mobile object M (whether the speaker is present inside or outside the vehicle cabin) can be recorded, and the collected audio may be processed in accordance with the positional relation.

The external sensor 125 detects positions of objects of the surroundings of the mobile object M. The external sensor 125, for example, is a radar device, a light detection and ranging (LIDAR) sensor, or any one of various kinds of proximity sensors. The radar device emits radio waves such as millimeter waves to the surroundings of the mobile object M and detects radio waves reflected by an object (reflected waves) to detect at least the position (a distance and orientation) of the object. The radar device may detect the position and the speed of an object using a frequency modulated continuous wave (FM-CW) method. The LIDAR sensor emits light (or electromagnetic waves with wavelengths close to that of light) to the surroundings of a mobile object M, measures the scattered light thereof, and detects the distance to a target based on a time from light emission to light reception. The irradiated light may be, for example, pulse-shaped laser light. The radar device and LIDAR sensor can be installed at an arbitrary portion of the mobile object M. The external sensor 125 may also detect surrounding objects using a captured image acquired by the outdoor camera 134 of the camera unit 130.

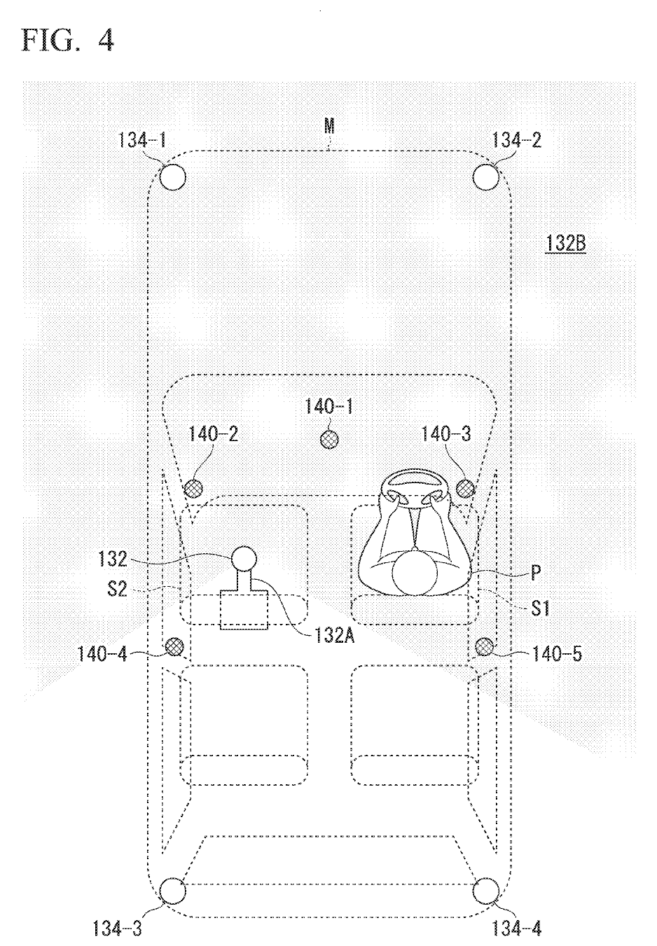

The camera unit 130 is an example of an imaging device and, for example, includes an indoor camera 132 and an outdoor camera 134. The camera unit 130 obtains control information obtained from the management server 300 through the first communication device 110 and adjusts the brightness based on the obtained control information. The first speaker 140 outputs the audio produced by the user U obtained through the first communication device 110. Details of the arrangement and the like of the camera unit 130 and the first speaker 140 are described below with reference to FIG. 4.

The user display device 150 virtually displays a user U as if the user U is present in an indoor space of the mobile object M. For example, the user display device 150 may cause a hologram to appear or display the user U in a part of the mobile object M that corresponds to a mirror or a window.

The HMI 160 is a touch panel, an audio response device (an agent device), or the like. The HMI 160 receives various instructions from the passenger P for the first device 100 or provides various kinds of information for the passenger P.

The first controller 170, for example, includes a processor such as a CPU and a storage medium that is connected to the processor and stores a program (a command group) and controls each part of the first device 100 by the processor executing the instruction group.

The control target equipment 190, for example, is an in-vehicle device such as a navigation device, which guides a route to a destination, mounted in the mobile object M, a driving assistance device that assists the drive of the passenger P by controlling one or both of steering or the speed of the mobile object M. The control target equipment 190, for example, includes a seat driving device capable of adjusting the seat position (forward, backward, left, and right), the orientation, and the height. In a case in which a video is seen using the second device 200, when the camera unit 130 of the first device 100 is mounted in the seat, by prohibiting the movement of the seat, the video can be suppressed from being affected. Also in a case in which the movement of the seat is permitted, in correspondence therewith, a process such as angle of view transformation or the like may be performed such that the video in the case of the movement of the seat is not affected. In a case in which a video outside the angle of view of the camera unit 130 in the current state is desired to be seen in accordance with a request from the user U, the seat driving device may be controlled as a request from the second device 200 side.

FIG. 4 is a diagram showing an example of the arrangement of a part of the first device 100 of the mobile object M. The indoor camera 132, for example, is attached to a neck pillow of a front passenger seat S2 (an example of “predetermined seat”) through an attachment 132A and is disposed at a position slightly deviating from the backrest of the front passenger seat S2 to the traveling direction side of the mobile object M. The indoor camera 132 has a wide-angle lens and is capable of imaging a range represented by a hatched area 132B in the drawing. The indoor camera 132 can capture not only an indoor area of the mobile object M but also an outdoor area through a window. In the following description, although the front passenger seat S2 is assumed to be the predetermined seat, the predetermined seat may be any other seat such as a rear seat.

The outdoor camera 134 includes, for example, a plurality of sub-outdoor cameras 134-1 to 134-4. By combining images captured by the plurality of sub-outdoor cameras 134-1 to 134-4, an image similar to a panorama image acquired by imaging the outside of the mobile object M can be acquired. Instead of (or in addition to) these, the outdoor camera 134 may include a wide-angle camera disposed on a loop of the mobile object M. In addition, as the indoor camera 132, a camera capable of imaging the rear side of the front passenger seat S2 may be added. A mobile object image to be described below may be generated as a 360-degrees panorama image by combining images captured by one or more indoor cameras 132 using the first controller 170 or may be generated as a 360-degrees panorama image by appropriately combining an image captured by the indoor camera 132 and an image captured by the outdoor camera 134.

The first speaker 140 outputs an audio of the user U obtained through the first communication device 110. The first speaker 140, for example, includes a plurality of sub-first speakers 140-1 to 140-5. For example, the sub-first speaker 140-1 is arranged at the center of an instrument panel. The sub-first speaker 140-2 is arranged at the left end of the instrument panel. The sub-first speaker 140-3 is arranged at the right end of the instrument panel. The sub-first speaker 140-4 is arranged in a lower part of the left door. The sub-first speaker 140-5 is arranged in a lower part of the right door.

In a case in which the first speaker 140 is caused to output an audio of the user U, the first controller 170, for example, causes the audio to be output with volumes of the same degree from the sub-first speaker 140-2 and the sub-first speaker 140-4 and turns the other sub-first speakers off. In accordance with this, the first controller 170 performs sound image localization such that the audio is heard from the front passenger seat S2 for the passenger P seated in the driver's seat S1. The method of sound image localization is not limited to volume adjustment and may also be performed by shifting the phase of the sound output from each of the sub-first speakers. For example, in a case in which sound image localization is performed such that the sound is heard from the left side, a timing at which the sound is output from the sub-first speaker of the left side may be configured to be slightly earlier than a timing at which the sound is output from the sub-first speaker of the right side.

In a case in which the first speaker 140 is caused to output the audio of the user U, the first controller 170 may perform sound image localization such that an audio is heard from a position with a height corresponding to the height of the head of the user U on the front passenger seat S2 for the passenger P. In such a case, the first speaker 140 needs to have a plurality of sub-first speakers 140-k (k represents multiple natural numbers) with different heights.

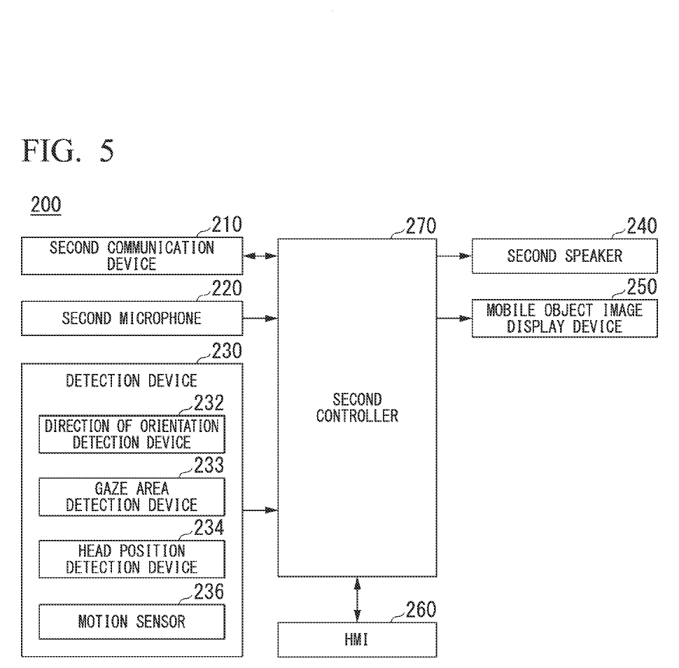

FIG. 5 is a configuration diagram of the second device 200. The second device 200, for example, includes a second communication device 210, a second microphone 220, a detection device 230, a second speaker 240, a mobile object image display device 250, an HMI 260, and a second controller 270. The detection device 230, for example, includes a direction of orientation detection device 232, a gaze area detection device 233, a head position detection device 234, and a motion sensor 236.

The second communication device 210 is a communication interface used for communicating with each of the communication devices 310 of the management server 300 and the first communication device 110 of the first device 100 through a network NW.

The second microphone 220 collects audio produced by a user U. The audio collected by the second microphone 220, for example, is transmitted to the first communication device 110 by the second communication device 210 via the second controller 270.

The direction of orientation detection device 232 is a device that is used for detecting an orientation direction. The orientation direction is a direction of the orientation of the face or the orientation of the visual line of a user U or a direction based on both thereof. Hereinafter, although the orientation direction is assumed to be at an angle in the horizontal plane, that is, an angle having no vertical-direction component, the orientation direction may be at an angle including also the vertical-direction component. The direction of orientation detection device 232 may include a physical sensor (for example, an acceleration sensor, a gyro sensor, or the like) mounted in VR goggles to be described below. The direction of orientation detection device 232 may be an infrared sensor that detects a plurality of positions of the head of the user U or a camera imaging the head of the user U. In any of the cases, the second controller 270 calculates an orientation direction based on information input from the direction of orientation detection device 232. Since various techniques regarding this are known, detailed description thereof will be omitted.

The gaze area detection device 233 is a device that is used for detecting a gaze area. The gaze area is an area at which the user U is carefully gazing. The gaze area detection device 233 may be a camera that images a visual line for being mounted in the VR goggles to be described below. The second controller 270 derives a gaze area based on information input from the gaze area detection device 233. Since various techniques regarding this are known, detailed description thereof will be omitted.

The head position detection device 234 is a device that is used for detecting the position (the height) of the head of the user U. For example, one or more infrared sensors or optical sensors disposed in the vicinity of a chair on which the user U is seated are used as the head position detection device 234. In this case, the second controller 270 detects the position of the head of the user U based on presence/absence of detection signals acquired by one or more infrared sensors or optical sensors. The head position detection device 234 may be an acceleration sensor mounted in VR goggles (a head mounted display (HMD) or the like). In such a case, the second controller 270 detects the position of the head of the user U by integrating a result acquired by subtracting the acceleration of gravity from the output of the acceleration sensor. The information of the position of the head acquired in this way is provided for the second controller 270 as height information.

The position of the head of the user may be obtained based on an operation of the user U on the HMI 260. For example, the user U may input the height to the HMI 260 as a numerical value or may input the height using a dial switch included in the HMI 260. In such a case, the position of the head, that is, height information is calculated from the height. The user U may input discrete values such as a physique: large/medium/small to the HMI 260 instead of continuous values. In such a case, height information is obtained based on information representing the body size. The height of the head of the user U may be simply obtained based on the general physique of an average adult (which may be gender-specific) without specifically obtaining the height of the head of the user.

The motion sensor 236 is a device for recognizing blinks and gesture operations performed by the user U. For example, a camera that images an upper half body of the user U is used as the motion sensor 236. In this case, the second controller extracts feature points of the face (the eyes, the nose, and the mouth) and feature points of the body (fingertips, wrists, elbows, and the like ) of the user U from an image captured by the camera and recognizes blinks and gesture operations of the user U based on the movements of the feature points.

The second speaker 240 outputs an audio, which has been produced by the passenger P, obtained through the second communication device 210. The second speaker 240, for example, has a function of changing the direction in which the audio is heard. The second controller 270 causes the second speaker to output an audio such that the user U hears the audio from the position of passenger P that is seen from the front passenger seat S2. The second speaker 240 includes a plurality of sub-second speakers 240-n (n represents multiple natural numbers), and the second controller 270 may perform sound image localization by adjusting the volume of each sub-second speaker 240-n. In a case in which the VR goggles are equipped with headphones, sound image localization may be performed using the function of the headphones.

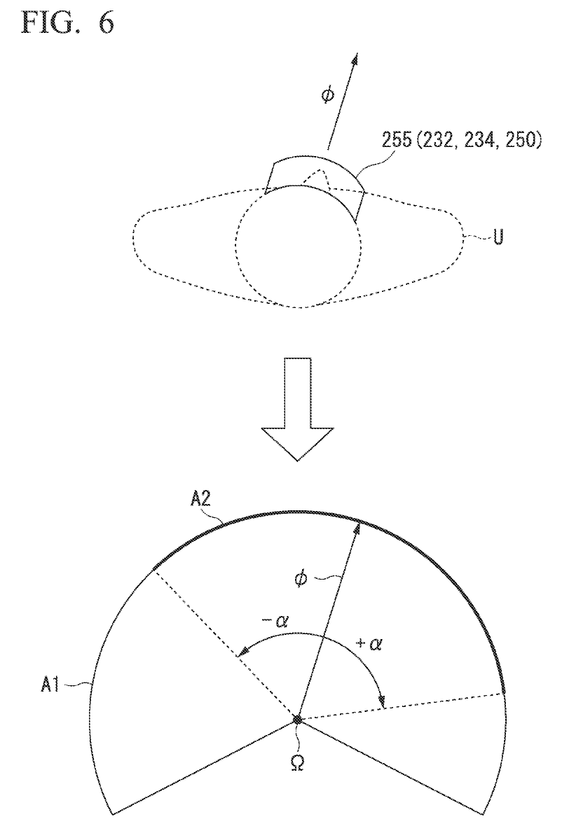

The mobile object image display device 250 displays an image corresponding to an orientation direction seen from the front passenger seat among images (may be images for which the combination process described above has been performed; hereinafter referred to as mobile object images) captured by the camera unit 130. FIG. 6 is a diagram showing an image corresponding to an orientation direction. In the example shown in this drawing, the VR goggles 255 include a direction of orientation detection device 232, a physical sensor as a head position detection device 234, and a mobile object image display device 250. The second controller 270, for example, sets the center of the head of the user U or the center of the VR goggles 255 as Ω and detects a direction in which the VR goggles 255 face as an orientation direction φ with a direction calibrated in advance set as a reference direction. Since various techniques are known for relating functions, detailed description will be omitted.

The mobile object image display device 250 displays an image A2 in the angle range of ±α with the orientation direction φ set as the center among mobile object images A1 (although it has an angle of about 240 degrees in the drawing, as described above, the angle of view may be expanded by the combination process described above) toward the user U.

The HMI 260 is a touch panel, an audio response device (agent device), the switch described above, or the like. The HMI 260 receives various instructions from the user U for the second device 200.

The second controller 270, for example, includes a processor such as a CPU and a storage medium that is connected to the processor and stores a program (a command group) and controls each part of the second device 200 by the processor executing the command group. In addition, all the functions of the second device 200 shown in FIG. 5 may be integrally configured with the VR goggles.

### Functional Configuration of First Controller 170 and Second Controller 270

Hereinafter, the functional configurations of the first controller 170 and the second controller 270 are described. In a first example and a second example below, mainly, generation, transmission, and the like of information provided between the first controller 170 and the second controller 270 are assumed to be performed, and the management server 300 manages matching of simulated riding of the passenger P and the user U.

### First Example

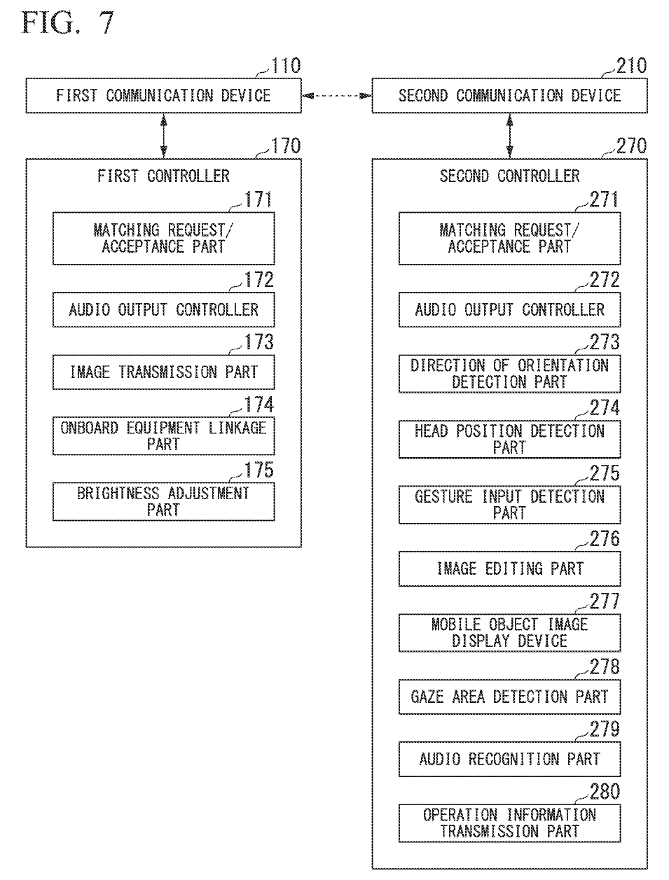

FIG. 7 is a diagram showing the first example of the functional configurations of the first controller 170 and the second controller 270. In the first example, the first controller 170 includes a matching request/acceptance part 171, an audio output controller 172, an image transmission part 173, an onboard equipment linkage part 174, and a brightness adjustment part 175. The second controller 270 includes a matching request/acceptance part 271, an audio output controller 272, a direction of orientation detection part 273, a head position detection part 274, a gesture input detection part 275, an image editing part 276, a mobile object image display controller 277, an audio recognition part 279, and an operation information transmission part 280. Such functional parts, for example, are realized by a processor such as a CPU executing a program (command group). Some or all of such constituent elements may be realized by hardware (circuit part; including circuitry) such as an LSI, an ASIC, an FPGA, and a GPU or may be realized by software and hardware in cooperation.

The matching request/acceptance part 171 receives an input of a matching request (a simulated riding request) from the passenger P using the HMI 160 and transmits the matching request to the management server 300 or receives an input of approval for a matching request received from the management server 300 using the HMI 160 and transmits the approval to the management server 300. The matching request/acceptance part 171 performs control of the first communication device 110 such that the second device 200 of the matched user U is set as a communication partner. For example, when a matching request acquired from the management server 300 is approved, the matching request/acceptance part 171 may accept setting of provision availability information representing which information is permitted to be provided from the passenger P.

The audio output controller 172, as described above, controls the first speaker 140.

After communication with the second device 200 starts, the image transmission part 173 transmits a mobile object image A1 to the second device 200 using the first communication device 110. The mobile object image A1, for example, may include an indoor image captured by the indoor camera 132 and/or an outdoor image captured by the outdoor camera 134.

The onboard equipment linkage part 174 controls the control target equipment 190 based on an instruction signal input from the second device 200. In addition, the onboard equipment linkage part 174 may perform control in a case in which control of the control target equipment 190 according to the user U is permitted from the passenger P.

The brightness adjustment part 175 adjusts the brightness of the mobile object image captured by the camera unit 130 based on control information for changing the brightness received from the management server 300.

The matching request/acceptance part 271 receives an input of a matching request (a simulated riding request) from the user U using the HMI 260 and transmits the matching request to the management server 300 or receives an input of approval for a matching request received from the management server 300 using the HMI 260 and transmits the approval to the management server 300. The matching request/acceptance part 271 performs control of the second communication device 210 such that the first device 100 of the matched passenger P is set as the communication partner. The matching request/acceptance part 271, for example, may present which information is provided to the user U to allow to confirm it based on a matching result (request result) acquired from the management server 300 and then accept an instruction indicating whether or not a simulated riding is performed from the user U.

The audio output controller 272, as described above, controls the second speaker 240.

The direction of orientation detection part 273 detects a direction of orientation φ based on the output of the direction of orientation detection device 232. The head position detection part 274 detects a height of the head of the user U based on the output of the head position detection device 234. The head position may be represented as three-dimensional coordinates, or the height of the head may be simply detected as the head position.

The gesture input detection part 275 detects an input of a blink and a gesture of the user U based on the output of the motion sensor 236.

The image editing part 276, for example, performs a process of cutting out an image A2 corresponding to this direction of orientation φ seen from the front passenger seat S2 from the mobile object image A1 (FIG. 6). In the example shown in FIG. 6, although the direction of orientation φ for leftward/rightward movement of the head of the user U is shown, a process of cutting out an image corresponding to a direction of orientation for the upward/downward movement of the head may be performed.

The mobile object image display controller 277 causes the mobile object image display device 250 to display the image A2 cut out by the image editing part 276. At this time, the image editing part 276 may cause the mobile object image display device 250 to display an image corresponding to this direction of orientation φ seen from the height represented by the height information of the head of the user U. For example, the image editing part 276 may display an indoor image or an outdoor image to be switched in correspondence with a distance from the reference position of the head of the user U (for example, the amount of upward movement or the amount of horizontal movement).

The gaze area detection part 278 derives a gaze area based on the output of the gaze area detection device 233. For example, the gaze area detection part 278 may set a point at which the direction of the visual line of the user U and a moving image displayed in the mobile object image display device 250 intersect with each other as the center and set a predetermined range from the center as a gaze area.

The audio recognition part 279 obtains an audio (speech) collected by the second microphone 220, recognizes the obtained audio, and converts the recognized audio into text information.

The operation information transmission part 280 accepts an input of a first operation performed by the user U using the HMI 260 for at least a partial area of a moving image displayed in the mobile object image display device 250 and transmits the input to the management server 300. The operation information transmission part 280 accepts text information converted by the audio recognition part 279 and transmits the accepted text information to the management server 300. The operation information transmission part 280 accepts information representing a gaze area derived by the gaze area detection part 278 and transmits information indicating the accepted gaze area to the management server 300. The operation information transmission part 280 accepts information representing a gaze area derived by the gaze area detection part 278. The operation information transmission part 280 judges that the user U is gazing at the gaze area for a predetermined time or more based on the accepted information representing the gaze area and, in a case in which information representing at least one of a blink and a gesture operation recognized by the gesture input detection part 275 is accepted, accepts an input of a second operation and transmits the input to the management server 300.

### Second Example

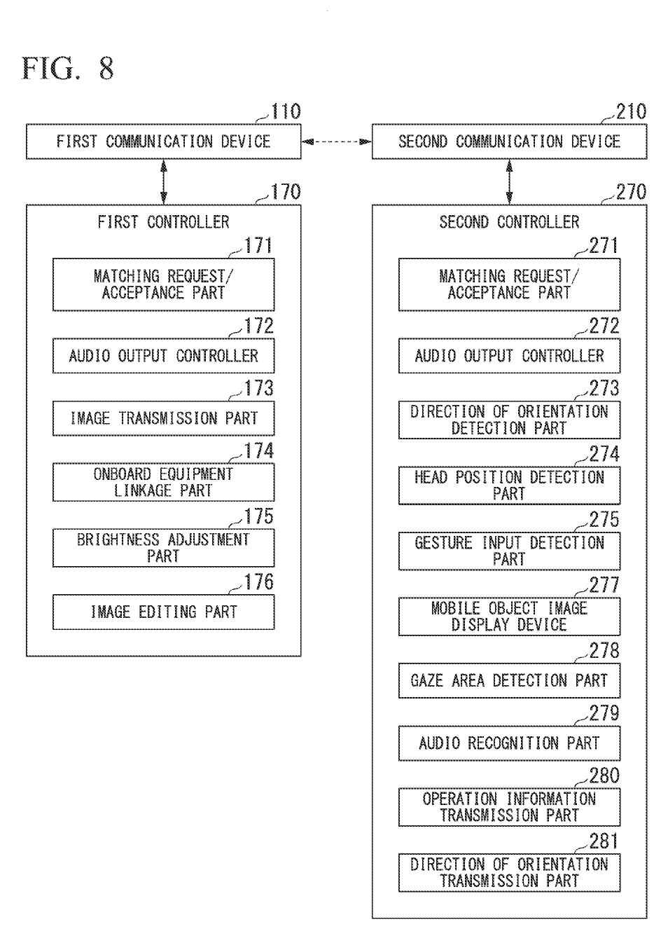

FIG. 8 is a diagram showing the second example of the functional configurations of the first controller 170 and the second controller 270. When compared with the first example shown in FIG. 7, the first controller 170 includes an image editing part 176, and the second controller 270 includes a direction of orientation transmission part 281 without including the image editing part 276, which is different from the first example. The other constituent elements have basically the same functions as those of the first example, and thus repetitive description will be omitted. The direction of orientation transmission part 281 transmits a direction of orientation φ detected by the direction of orientation detection part 273 to the first device 100 using the second communication device 210.

The image editing part 176 performs a process of cutting out an image A2 corresponding to the direction of orientation φ (transmitted from the second device 200) seen from the front passenger seat from the mobile object image A1 (FIG. 6). At this time, the image editing part 176 may obtain the height information of the head of the user U from the second device 200 and perform a process of cutting out the image A2 corresponding to the direction of orientation φ seen from the height represented by the height information.

The image transmission part 173 of the second example transmits the image A2 cut out by the image editing part 176 to the second device 200 using the first communication device 110. Then, the mobile object image display controller 277 causes the mobile object image display device 250 to display the image A2 transmitted from the first device 100.

### Process relating to Simulated Riding

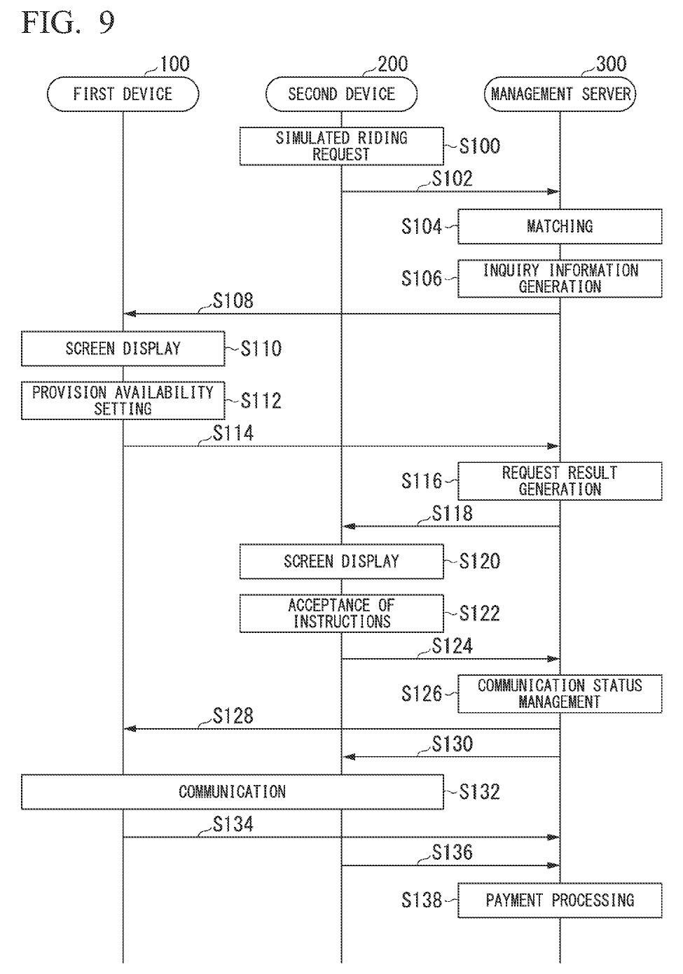

Next, in the embodiment, a series of processes executed by the information processing system 1 of a case in which the user U performs simulated riding for the mobile object M (the passenger P allows the user U to perform simulated riding) will be described more specifically. FIG. 9 is a sequence diagram showing an example of a process executed by the information processing system 1. The example of FIG. 9 shows processes of the first device 100 mounted in the mobile object M in which the passenger P is riding, the second device 200 used by the user U, and the management server 300. Here, in order to receive provision of a service of the information processing system 1, the user U and the passenger P are registered in the management server 300 in advance and are registered in the user data 360.

In the example shown in FIG. 9, the second device 200 generates a request for simulated riding (a simulated riding request) (Step S100) and transmits the generated simulated riding request to the management server 300 (Step S102). The simulated riding request, for example, may include information designating the passenger P in advance or may include information designating a current location or a destination of a mobile object M during traveling, surrounding situations, and the like. As a more specific example of the simulated riding request, for example, there is a request for “simulated riding for a mobile object driven by Mr. A” or “simulated riding for a mobile object traveling on a coastal road”. These are examples of the matching request described above.

The matching processing part 320 of the management server 300 receives a simulated experience request from the second device 200 and performs a matching process based on the user data 360 (Step S104). Then, in a case in which there are one or more matched mobile objects M, the provision part 330 generates inquiry information for inquiring about whether or not simulated riding is performed for all the mobile objects M (Step S106) and transmits the generated information to the first devices 100 of the matched mobile objects M (Step S108).

The first device 100 displays the inquiry information transmitted from the management server 300 on the screen (Step S110). FIG. 10 is a diagram showing an example of an image IM10 representing inquiry information. Display aspects such as display details, a layout, and the like included in the image IM10 are not limited thereto. This similarly applies also to description of subsequent images. In the image IM10, as an inquiry screen, for example, a user information display region AR11, a provision availability selection region AR12, and a switch display region AR13 are included. Information relating to a user U having a simulated riding request is displayed in the user information display region AR11. The information relating to a user U may be a user ID or may be any other information enabling the passenger P to identify the user U.

An image used for selecting details of information provided for the user U by the passenger P for each piece of information is displayed in the provision availability selection region AR12. In the example shown in FIG. 10, a screen for selecting whether or not information is provided for the passenger P is displayed for an indoor image, an outdoor image, a phone call (audio), and navigation information (information provided from a navigation device). The phone call (audio) is an example of “indoor audio information”. For example, in a case in which a phone call and provision of images are allowed for a user U, and the destination is desired not to be specifically known to the user, the passenger P permits provision of phone calls and an indoor image and an outdoor image and denies provision of the navigation information.

In accordance with this, for example, although the designation can be simply known based on the navigation information in a case in which a user U is actually riding on the mobile object M, by not providing the navigation information at the time of simulated riding, the mobile object can be headed for the destination without informing the user U, and thus the user U can go through a surprising experience that is unique to the simulated riding. For example, by denying provision of a phone call (audio) for user U who is not very familiar, driving can be performed without any conversation.

The information for selecting provision availability is not limited to the example shown in FIG. 10, and, for example, and it may include information for selecting availability of a navigation operation or operations on other control target equipment 190 according to the user U and information for selecting availability of provision of images including the passenger P. In addition, the availability of provided information selected in the provision availability selection region AR12 may be changed during the simulated riding. For example, icon IC11 and icon IC12 are included in the switch display region AR13. The icon IC11 is a switch for accepting permission for simulated riding of the user U from the passenger P. To the contrary, the icon IC12 is a switch for accepting denial for simulated riding of the user U from the passenger P.

Referring back to FIG. 9, the first device 100 accepts the provision availability setting of the user U using the image IM10 and the like shown in FIG. 10 described above (Step S112) and transmits the accepted provision availability setting information to the management server 300 (Step S114). In addition, in order to ensure safety while driving, the processes of Steps S110 to S112 may be displayed on the screen in a case in which the mobile object M is stopped, and instead of (or in addition to) the screen display, by using audio, presence of a simulated riding request may be notified, or the provision availability setting may be accepted. The provision part 330 of the management server 300 generates a request result (reply result) based on the provision availability setting information acquired from the first device 100 (Step S116) and transmits information representing the generated request result to the second device 200 (Step S118).

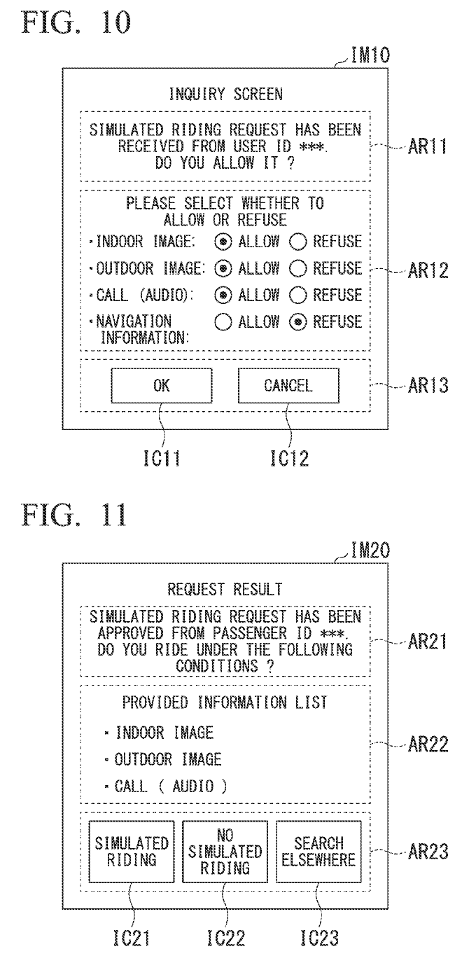

The second device 200 receives a request result from the management server 300 and displays information representing the received request result on the screen (Step S120). FIG. 11 is a diagram showing an example of the image IM20 that represents a request result. In the image IM20, as a request result screen, for example, a passenger information display region AR21, a provided information list display region AR22, and a switch display region AR23 are included. This image IM20 may be generated for each passenger P (the mobile object M) permitted for simulated riding, and furthermore an image representing a list of request results may be displayed.

In the passenger information display region AR21, information relating to the passenger P who has been permitted for a simulated riding request is displayed. The information relating to the passenger P may be a passenger ID or may be any other information from which the user U can identify the passenger P. In the provided information list display region AR22, information permitted by the passenger P is displayed as a list. In the provided information list display region AR22, a fee (service usage fee) based on the permitted information may be displayed. In the switch display region AR23, for example, icons IC21 to IC23 are included. The icon IC21 is a switch that accepts simulated riding in the mobile object M of the passenger P displayed in the passenger information display region AR21 with provided information displayed in the provided information list display region AR22. To the contrary, the icon IC22 is a switch that accepts no simulated riding. The icon IC23 is a switch that accepts to find out another passenger (mobile object). In a case in which another passenger is to be found, the passenger may be selected from other passengers included in the request result, or other request conditions may be input to cause the management server 300 to perform the matching process again.

Referring back to FIG. 9, the second device 200 accepts a selection instruction from the user U using the image IM20 shown in FIG. 11 described above (Step S122) and transmits the accepted instruction information to the management server 300 (Step S124). Hereinafter, it is assumed that the user U has made an instruction for simulated riding of the passenger P in the mobile object M. The management server 300 manages the communication statuses of the first device 100 and the second device 200 based on an instruction from the second device 200 (Step S126) and transmits information representing execution of simulated riding to the first device 100 and the second device 200 (Steps S128 and S130). In addition, in the processes of Steps S126 to S130, in a case in which it is selected that the user U does not perform simulated riding, the provision part 330 of the management server 300 transmits information representing the indication thereof to the first device 100 to notify the user U thereof.

Next, the first device 100 and the second device 200 communicate with each other to execute simulated riding (Step S132), and when the simulated riding ends, transmit information representing the end of the communication to the management server 300 (Steps S134 and S136). In addition, in the process of Step S132, before the information from the first device 100 is provided for the second device 200, the second device 200 may give a notification from the user U to the passenger P. In accordance with this, the user U can start information provision such as a phone call or moving image distribution by permitting communication at his or her timing. Next, the fee management part 340 of the management server 300 performs a settlement process for a fee relating to the service usage of each of the first device 100 and the second device 200. More specifically, the fee management part 340 sets the fee relating to information provision based on at least one of the passenger P providing information, the user U, the type of mobile object M, the type of information that can be provided for the user U, and the amount of information. For example, in a case in which the passenger P or the user U is a celebrity, the usage fee may be set above a normal fee, and in a case in which the mobile object M is brand-new or a rare vehicle, the fee may also be set higher than the normal fee. Then, the fee management part 340 performs a settlement process corresponding to the set fee. In accordance with this, the process of the present sequence ends. In addition, the process (provision availability setting process) of Step S112 shown in FIG. 9 may be set by the passenger P in advance for each registered user U.

### Process relating to Brightness Adjustment

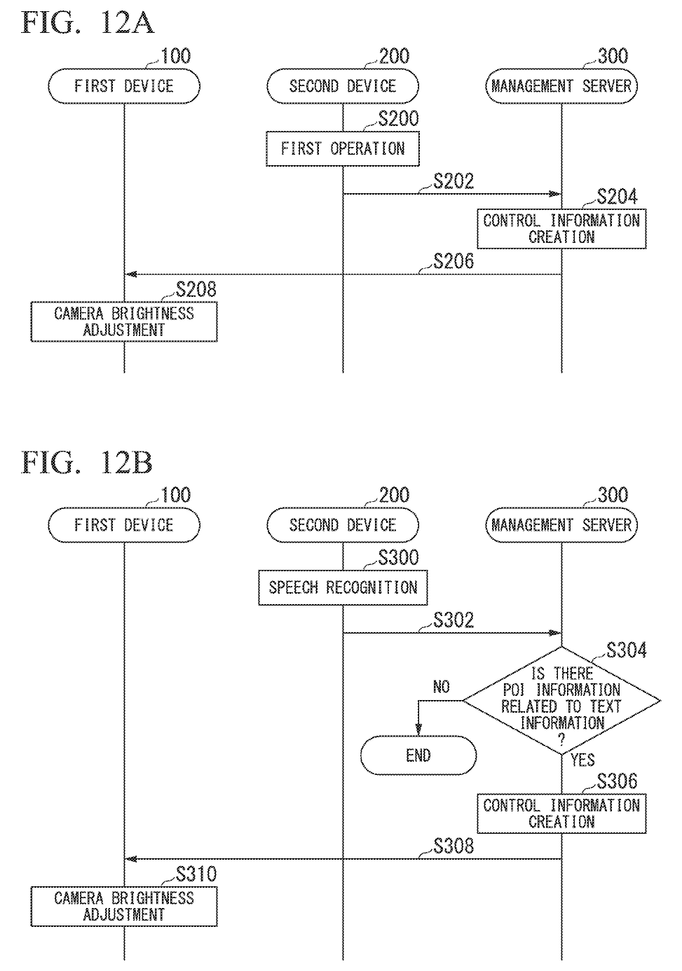

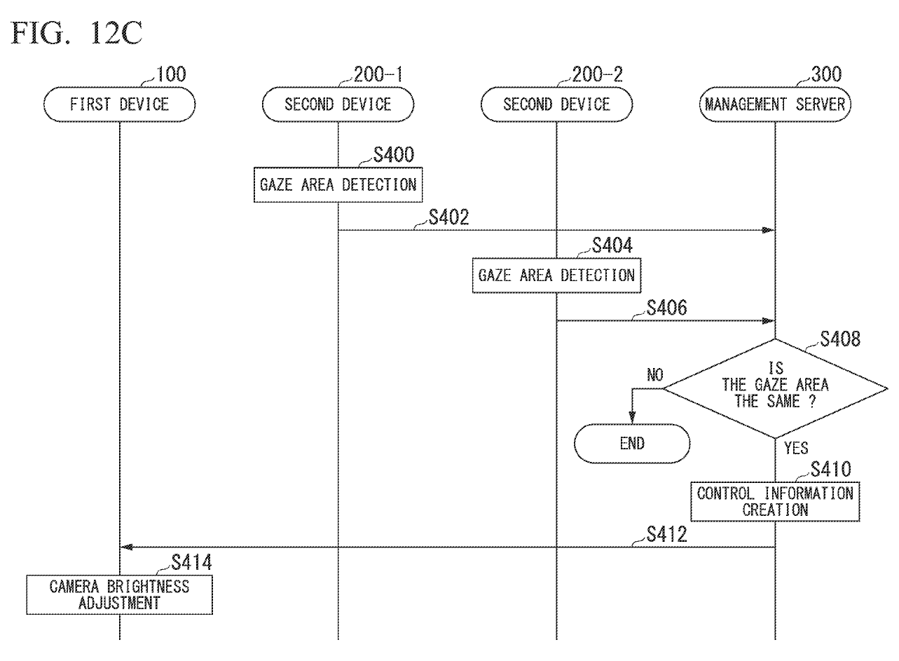

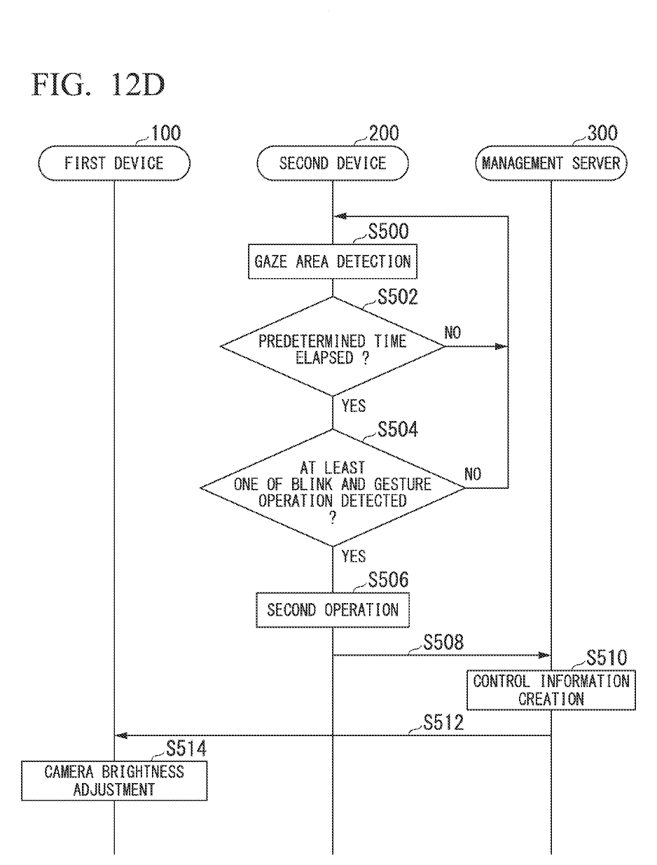

Next, in the embodiment, a series of processes executed by the information processing system 1 of a case in which a user U performs simulated riding in the mobile object M, and the brightness is adjusted based on a request of the user U will be described more specifically. FIG. 12A is a sequence diagram showing a first example of the process executed by the information processing system 1. The first device 100 and the second device 200 communicate with each other to execute simulated riding.

In the example shown in FIG. 12A, the second device 200 accepts an input of a first operation according to the user U (Step S200) and transmits first operation information to the management server 300 based on the accepted first operation (Step S202). The first operation, for example, may be a tap operation performed by the user U using the HMI 260 for at least a partial area of a moving image displayed in the mobile object image display device 250. For example, the user U taps on an arbitrary place included in a moving image displayed in the mobile object image display device 250. The place may be a place desired to be seen from a remote place by the user U. The HMI 260 obtains an input of a tap operation performed by the user U. The operation information transmission part 280 accepts a tap operation obtained by the HMI 260, generates first operation information including information representing a tap-operated area, and transmits the generated first operation information to the management server 300. An example of the information representing an area represents coordinates of at least a part of the boundary of the area in the mobile object image display device 250.

Next, the brightness modification part 334 of the management server 300 generates control information for changing the brightness of a partial area of the moving image based on the first operation information from the second device 200 (Step S204) and transmits the generated control information to the first device 100 (Step S206).

For example, the reception part 332 obtains the first operation information, which has been supplied from the second device 200, from the communication device 310 and accepts it. The brightness modification part 334 obtains the first operation information from the reception part 332 and identifies a camera imaging a partial area of the moving image for which the first operation has been performed based on the obtained first operation information. Here, the brightness modification part 334 may store camera moving image area association information that associates information representing a plurality of cameras included in the camera unit 130 with information representing areas of moving images captured by the plurality of cameras. For example, by dividing the area of a front glass into three parts to be set as left/center/right areas, areas of moving images respectively captured by the plurality of cameras may be set, and the area of the front glass may be set by dividing it into six parts. In this case, the brightness modification part 334 obtains information representing a camera associated with information representing a partial area of the moving image, for which the first operation has been performed, included in the first operation information and generates control information for changing the brightness using the camera based on the information representing the obtained camera.

Next, the camera unit 130 of the first device 100 adjusts the brightness based on the control information supplied from the management server 300 (Step S208). For example, any one of the indoor camera 132 and the outdoor camera 134 obtains control information from the first controller 170 and adjusts an exposure value (EV value) based on the obtained control information, whereby the brightness is adjusted. Thereafter, any one of the indoor camera 132 and the outdoor camera 134 may perform brightness adjustment based on the brightness of the surroundings thereof. In accordance with this, for example, in a case in which the external environment changes in accordance with traveling to change the brightness of the surroundings, the brightness can be dynamically adjusted such that a portion indicated by the user U is easily seen constantly.

FIG. 12B is a sequence diagram showing a second example of the process executed by the information processing system 1. The first device 100 and the second device 200 communicate with each other to execute simulated riding.

In the example shown in FIG. 12B, the second device 200 collects an audio (speech) of the user U, performs speech recognition of the collected audio (Step S300), and transmits the recognized audio to the management server 300 (Step S302). For example, the second microphone 220 collects the audio (speech) of the user U. The audio recognition part 279 obtains the audio (speech) collected by the second microphone 220, recognizes the obtained audio, and converts it into text information. The operation information transmission part 280 accepts the text information converted by the audio recognition part 279 and transmits the accepted text information to the management server 300.

Next, the brightness modification part 334 of the management server 300 judges whether or not POI information associated with the text information is present based on the text information from the second device 200 (Step S304). In a case in which the POI information is present, control information for changing the brightness of the area of the POI information included in a part of the moving image is generated (Step S306) and is transmitted to the first device 100 (Step S308). For example, the reception part 332 obtains text information, which has been supplied from the second device 200, from the communication device 310 and accepts the text information. The brightness modification part 334 obtains the text information from the reception part 332 and judges whether or not POI information associated with the text information is included in the POI information registered in the provided information DB 362 stored in the storage part 350. In a case in which POI information associated with the text information is included in the POI information registered in the provided information DB 362, the brightness modification part 334 identifies a camera imaging the associated POI information from the moving image data provided for the second device 200 by the provision part 330 among the cameras included in the camera unit 130 and generates control information for changing the brightness using the identified camera. In a case in which POI information associated with the text information is not included in the POI information registered in the provided information DB 362, the brightness modification part 334 ends the process.

Step S310 is similar to Step S208 shown in FIG. 12A, and thus description thereof will be omitted. Thereafter, any one of the indoor camera 132 and the outdoor camera 134 may be configured to perform brightness adjustment based on the brightness of the surroundings. In accordance with this, for example, in a case in which the external environment changes in accordance with traveling to change the brightness of the surroundings, the brightness can be dynamically adjusted such that the POI information associated with the text information is easily seen constantly.

FIG. 12C is a sequence diagram showing a third example of the process executed by the information processing system 1. A first device 100, a second device 200-1, and a second device 200-2 communicate with each other to execute simulated riding.

In the example shown in FIG. 12C, the second device 200-1 detects a gaze area gazed by a user U1 (hereinafter, referred to as “first gaze area”) (Step S400) and transmits information representing the detected first gaze area to the management server 300 (Step S402). The second device 200-2 detects a gaze area gazed by a user U2 (hereinafter, referred to as “second gaze area”) (Step S404) and transmits information representing the detected second gaze area to the management server 300 (Step S406). For example, in the second device 200-1, the gaze area detection part 278 derives the first gaze area gazed by the user U1. The operation information transmission part 280 accepts information representing the first gaze area derived by the gaze area detection part 278 and transmits information representing the accepted first gaze area to the management server 300. In the second device 200-2, the gaze area detection part 278 derives the second gaze area gazed by the user U2. The operation information transmission part 280 accepts information representing the second gaze area derived by the gaze area detection part 278 and transmits information representing the accepted second gaze area to the management server 300.

Next, the brightness modification part 334 of the management server 300 judges whether or not the gaze areas are identical based on the information representing the first gaze area supplied from the second device 200-1 and the information representing the second gaze area supplied from the second device 200-2 (Step S408), generates control information for changing the brightness of a partial area of the moving image in the case of being identical (Step S410), and transmits the generated control information to the first device 100 (Step S412). For example, the reception part 332 obtains the information representing the first gaze area supplied from the second device 200-1 and the information representing the second gaze area supplied from the second device 200-2 from the communication device 310 and accepts the information. The brightness modification part 334 obtains the information representing the first gaze area and the information representing the second gaze area from the reception part 332 and judges whether or not the gaze areas are identical. Here, the gaze areas being identical includes at least a part of the first gaze area and the second gaze area being identical. In a case in which the gaze areas are not identical, the process ends. In a case in which the gaze areas are identical, the brightness modification part 334 generates control information for changing the brightness using a camera imaging the gaze area at which the user U is gazing at among the cameras included in the camera unit 130. Here, the brightness modification part 334 may store camera moving image area association information that associates information representing the plurality of cameras included in the camera unit 130 with information representing areas of moving images captured by the plurality of cameras. In such a case, the brightness modification part 334 obtains information representing a camera associated with the information representing the gaze area at which the user U is gazing based on the camera moving image area association information and generates control information for changing the brightness using the camera based on the information representing the obtained camera.

Step S414 is similar to Step S208 shown in FIG. 12A, and thus the description thereof will be omitted. Thereafter, any one of the indoor camera 132 and the outdoor camera 134 may be configured to adjust the brightness based on the brightness of the surroundings. In accordance with this, for example, when the external environment changes according to traveling to change the brightness of the surroundings, the brightness can be dynamically adjusted such that the gaze area at which the user U is gazing is easily seen constantly.

FIG. 12D is a sequence diagram showing a fourth example of the process executed by the information processing system 1. The first device 100 and the second device 200 communicate with each other to execute simulated riding.

In the example shown in FIG. 12D, the second device 200 detects a gaze area at which the user U is gazing (Step S500) and judges whether or not a predetermined time has elapsed in the state in which the user U is gazing at the gaze area (Step S502). In a case in which the predetermined time has not elapsed (Step S502: No), the process returns to Step S500. In a case in which the predetermined time has elapsed (Step S502: Yes), it is judged whether or not at least one of a blink or a gesture of the user U has been detected (Step S504).

For example, the gaze area detection part 278 derives a gaze area at which the user U is gazing. The operation information transmission part 280 obtains information representing the gaze area from the gaze area detection device 233 and judges whether or not the user U has gazed at the gaze area for the predetermined time or more based on the information representing the obtained gaze area. The motion sensor 236 recognizes a blink and a gesture operation performed by the user U. The operation information transmission part 280 obtains a recognition result of a blink and a gesture operation of the user U from the motion sensor 236 and judges whether or not information representing at least one of the blink and the gesture operation has been received.

Next, in a case in which the information representing at least one of the blink and the gesture operation has been received, the operation information transmission part 280 of the second device 200 accepts an input of a second operation (Step S506) and transmits the input to the management server 300 (Step S508). Examples of the second operation include blinking at constant intervals, closing the eyes for one second or more, and speech of “adjustment”.

The brightness modification part 334 of the management server 300 generates control information for changing the brightness of a partial area of the moving image based on the second operation information supplied from the second device 200 (Step S510) and transmits the generated control information to the first device 100 (Step S512).

For example, the reception part 332 obtains the second operation information supplied from the second device 200 from the communication device 310 and accepts the second operation information. The brightness modification part 334 obtains the second operation information from the reception part 332, obtains information representing a gaze area based on the obtained second operation information, and generates control information for changing the brightness using a camera imaging a gaze area at which the user U is gazing among the cameras included in the camera unit 130. Here, the brightness modification part 334 may store camera moving image area association information that associates information representing the plurality of cameras included in the camera unit 130 with information representing areas of moving images captured by the plurality of cameras. In such a case, the brightness modification part 334 obtains information representing a camera associated with the information representing the gaze area at which the user U is gazing based on the camera moving image area association information and generates control information for changing the brightness using the camera based on the information representing the obtained camera.

Step S514 is similar to Step S208 shown in FIG. 12A, and thus the description thereof will be omitted. Thereafter, any one of the indoor camera 132 and the outdoor camera 134 may be configured to adjust the brightness based on the brightness of the surroundings. In accordance with this, for example, also in a case in which the external environment changes according to traveling to change the brightness of the surroundings, the brightness can be dynamically adjusted such that the gaze area at which the user U is gazing is easily seen constantly. In FIG. 12D, as an example, although a case in which there are two second devices 200 has been described, it can be applied also to a case in which there are three or more second devices.

### Information Provided at Time of Simulated Riding

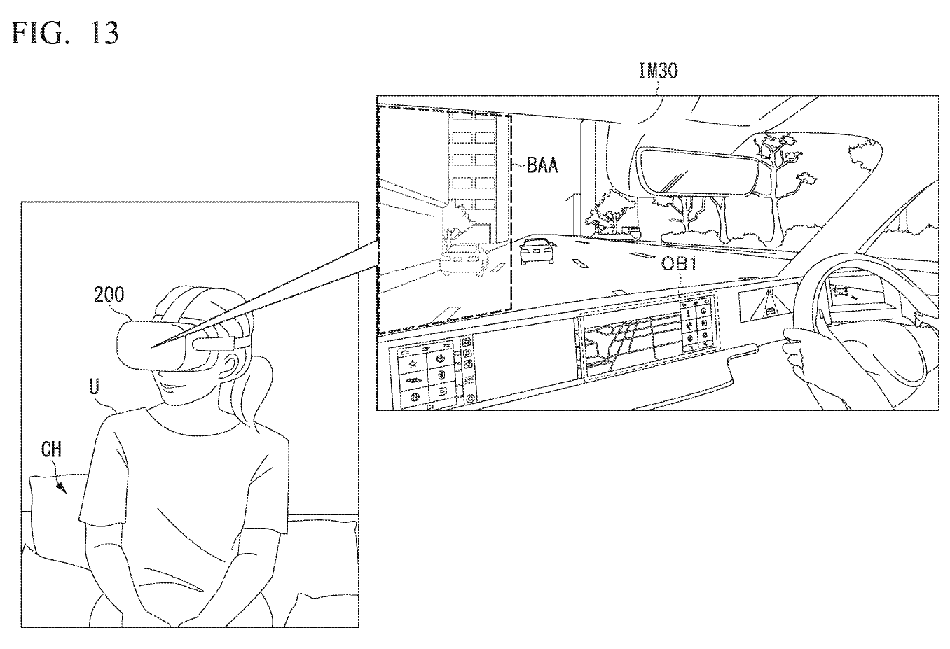

Next, information that is provided for the user U at the time of simulated riding is described. FIG. 13 is a diagram showing an example of provided information. In the following example, the information is information provided in the process of Step S208 shown in FIG. 12A, the process of Step S310 shown in FIG. 12B, the process of Step S414 shown in FIG. 12C, and the process of Step S514 shown in FIG. 12D and includes a brightness change area BAA in which the brightness is changed in a partial area of the moving image V. The output form of information provided for the second device 200 differs in accordance with the operation according to the user U and the type of information that can be provided for the user U or the amount of the information. In the following example, it is assumed that provision of an indoor image, an outdoor image, and a phone call (audio) is permitted by the passenger P.

In the embodiment described above, in a case in which any one of the first operation information and the second operation information is obtained from a plurality of second devices, the brightness modification part 334 may give priority for adjusting the brightness to a second device connected to the management server 300. In accordance with this, also in a case in which either the first operation information or the second operation information from a plurality of second devices contends, brightness adjustment can be performed without performing the process of determining a second device to which the priority is given.

In the embodiment described above, in a case in which information representing a partial area of the moving image, for which the first operation has been performed, included in the first operation information from a plurality of second devices contends, the brightness modification part 334 may be configured to notify each of the plurality of second devices contending each other of the contention. In accordance with this, the users U of the plurality of second devices to which contention has been notified can determine which user U’s first operation information is to be employed through exchange among the users.

In the embodiment described above, in a case in which first operation information from a plurality of second devices contend with each other, the brightness modification part 334 may judge whether or not POI information associated with the surroundings of a plurality of partial areas of the moving image is included based on the information representing a partial area of the moving image included in each of the plurality of pieces of first operation information contending with each other. For example, the brightness modification part 334 obtains POI information from the provided information DB 362 of the storage part 350. In a case in which POI information associated with the surroundings of one area among a plurality of partial areas of the moving image is included, the brightness modification part 334 may adjust the brightness of the area from which the POI information has been detected or the POI information.

Here, in a case in which POI information associated with the surroundings of each of a plurality of areas among a plurality of partial areas of the moving image is included, the brightness modification part 334 may notify each of a plurality of second devices of which the first operation information contends with each other of an overview of a plurality of pieces of POI information. In accordance with this, users U of the plurality of second devices to which the overview of the plurality of pieces of POI information has been notified can determine which user U’s first operation information is to be employed through exchange among the users.

### Summary

According to the information processing system 1 configured as described above, an information processing device processes information provided for a second device 200, which is used at a place different from that of a mobile object by a user U, from a first device 100 mounted in the mobile object. The information processing device includes an acquisition part 315, a provision part 330, a reception part 332, and a brightness modification part 334. The acquisition part 315 is configured to obtain information including moving image data transmitted by the first device 100. The provision part 330 is configured to provide moving image data for the second device 200 based on the information obtained by the acquisition part 315. The reception part 332 is configured to accept a first operation performed for a partial area of a moving image presented to the user U based on the moving image data provided for the second device 200 by the provision part 330. The brightness modification part 334 is configured to change brightness of the partial area of the moving image based on the first operation accepted by the reception part 332.

A process for enabling easy viewing of moving image data (video data) transmitted by the first device 100 can be remotely performed using the second device 200, and thus the convenience can be improved. Since the brightness can be changed from not the first device 100 distributing moving image data but the second device 200 that is viewed in accordance with reception of provision of moving image data, and thus, the convenience can be improved more than in a case in which the brightness can be changed only from the first device 100. Since a video of which the brightness has been adjusted can be distributed, white clip and black crush can be caused not to be generated in a place desired to be viewed.

In the information processing device, the first device 100 includes an imaging device. The brightness modification part 334 generates control information for causing the imaging device to change the brightness based on the first operation accepted by the reception part 332.

The control information for causing the imaging device to change the brightness can be generated based on the first operation, and thus the brightness of the imaging device included in the first device 100 can be controlled.

In the information processing device, the reception part 332 notifies the mobile object that a first operation changing the brightness has been performed based on the accepted first operation.

The mobile object to which it has been notified that the first operation changing the brightness has been performed can provide a topic by notifying a passenger that the first operation changing the brightness has been performed. For this reason, communication among passengers can be facilitated. For example, in a case in which the first operation changing the brightness is performed for a place having a good scenery, a topic relating to the place can be provided.

In the information processing device, the imaging device performs brightness adjustment of the partial area based on brightness of the surroundings.

Even in a case in which the brightness of the surroundings is changed in accordance with a change in the external environment according to the traveling of the mobile object, brightness adjustment can be dynamically performed such that a place instructed from the user U can be easily viewed constantly.

In the information processing device, a detection part configured to detect a gaze area at which the user U of the moving image is gazing is further included. The brightness modification part 334 changes brightness of the gaze area on the moving image based on the gaze area detected by the detection part.

The process enabling moving image data (video data) transmitted by the first device 100 to be easily viewed can be remotely performed without performing an operation using the second device 200, and thus the convenience can be improved more than in a case in which the brightness is changed through an operation.

In the information processing device, an audio recognition part 279 configured to detect an audio and perform speech recognition is further included. The brightness modification part 334 adjusts brightness of relating POI information in a case in which an audio recognized by the audio recognition part 279 relates to Point of Interest (POI) information of the surroundings of the mobile object.

The process enabling moving image data (video data) transmitted by the first device 100 to be easily viewed can be remotely performed without performing an operation using the second device 200, and the brightness of the POI information of the surroundings of the mobile object relating to an audio can be adjusted. In accordance with this, the convenience can be improved more than in a case in which the brightness is changed through an operation.

In the information processing device, a detection part configured to detect a gaze area at which the user U of the moving image is gazing is further included. The reception part 332 accepts a second operation in a case in which the detection part detects that a partial area of the moving image is being gazed for a predetermined time or more. The brightness modification part 334 changes brightness of the partial area of the moving image based on the second operation accepted by the reception part 332. The second operation includes a blink, a gesture, and speech. For this reason, the number of actions included in the second operation is larger than the number of actions included in the first operation.

The process enabling easy viewing of moving image data (video data) transmitted by the first device 100 can be remotely performed in a case in which a partial area of the moving image is gazed at for a predetermined time or more, and the second operation is performed.

In the information processing device, the brightness modification part 334 gives priority for brightness adjustment to the second device 200 that has been connected to the information processing device first among a plurality of second devices 200.

The process enabling moving image data (video data) transmitted by the first device 100 to be easily viewed can be remotely performed using the second device 200 to which priority is given according to first connection, and thus the convenience can be improved.

In the information processing device, in a case in which the first operations from a plurality of second devices 200 accepted by the reception part 332 contend with each other, the brightness modification part 334 notifies the plurality of second devices 200 contending with each other of the contention.

A user U of each of a plurality of second devices to which being contending with each other is notified can determine the first operation information of a certain user U to be employed through exchange among users. For this reason, even in a case in which the first operation information from a plurality of second devices contend with each other, the process enabling moving image data (video data) transmitted by the first device 100 to be easily viewed can be remotely performed using the second device 200. Accordingly, the convenience can be improved.

In the information processing device, in a case in which the first operations from a plurality of second devices 200 contend with each other, the brightness modification part 334 performs a process of detecting POI information of the surroundings of a partial area of the moving image for which the first operation has been performed by a user U of each of the plurality of second devices 200 contending with each other and, in a case in which the POI information has been able to be detected, adjusts brightness of an area in which the POI information has been detected or the POI information.

Since the brightness of an area in which POI information of the surroundings of a partial area of a moving image, for which the first operation has been performed, has been detected or the POI information can be adjusted, the process of enabling the moving image data (video data) transmitted by the first device 100 to be further easily viewed can be performed.

In the information processing device, in a case in which the first operations from a plurality of second devices 200 accepted by the reception part 332 contend with each other, the brightness modification part 334 performs a process of detecting POI information of the surroundings of a partial area of the moving image for which the first operation has been performed by a user U of each of the plurality of second devices 200 contending with each other and, in a case in which a plurality of pieces of the POI information has been able to be detected, notifies the user U of each of the plurality of second devices 200, of which the first operations contend with each other, of an overview of a plurality of pieces of the POI information.

Since the POI information of the surroundings of a partial area of a moving image for which the first operation has been performed by a user U of each of a plurality of second devices contending with each other is detected, and an overview of a plurality of pieces of POI information can be notified to a user U of each of the plurality of second devices 200, the convenience can be improved.

### Usage Example

The information processing system 1 can be used in the following forms.

(A) A form in which a passenger P and a user U have relationships such as family members, friends, or the like, and a virtual drive is provided for the user U. The user U can talk with the passenger P about the scenery around the mobile object M while viewing an image.

(B) A form in which a passenger P is a general user, and a user U is a provider of services such as a navigation assistance service or driving instruction service. The user U can perform route guidance and give driving operation instructions at places that are difficult to identify using a navigation device or are not represented on a map while viewing landscapes of the surroundings of the mobile object M.

(C) A form in which a passenger P is a celebrity, a user U is a general user, and a commercial-based virtual drive is provided for the user U. In this case, a plurality of users U are associated with a single passenger P at the same time, and, for example, audio transmission from the user U side may be set to off. By paying an additional fee, the user U may be able to have a phone call with the passenger P for a predetermined time.

As above, although forms for performing the present invention have been described using the embodiments, the present invention is not limited to such embodiments at all, and various modifications and substitutions may be added within a range not departing from the gist of the present invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Information processing system

100 First device

110 First communication device

120 First microphone

125 External sensor

130 Camera unit

132 Indoor camera

134 Outdoor camera

140 First speaker

150 User display device

160 HMI

170 First controller

190 Control target equipment

200 Second device

210 Second communication device

220 Second microphone

230 Detection device

232 Direction of orientation detection device

233 Gaze area detection device

234 Head position detection device

236 Motion sensor

240 Second speaker

250 Mobile object image display device

260 HMI

270 Second controller

300 Management server

310 Communication device

315 Acquisition part

320 Matching processing part

330 Provision part

332 Reception part

334 Brightness modification part

340 Fee management part

350 Storage part

M Mobile

What is claimed is:

1. An information processing device that processes information provided for a second device, which is used at a place different from that of a mobile object by a user, from a first device mounted in the mobile object, the information processing device comprising:
an acquisition part configured to obtain information including moving image data transmitted by the first device;
a provision part configured to provide moving image data for the second device based on the information obtained by the acquisition part;
a reception part configured to accept a first operation performed for a partial area of a moving image presented to the user based on the moving image data provided for the second device by the provision part; and
a brightness modification part configured to change brightness of the partial area of the moving image based on the first operation accepted by the reception part.

2. The information processing device according to claim 1,
wherein the first device includes an imaging device, and
wherein the brightness modification part generates control information for causing the imaging device to change the brightness based on the first operation accepted by the reception part.

3. The information processing device according to claim 1, wherein the reception part notifies the mobile object that a first operation changing the brightness has been performed based on the accepted first operation.

4. The information processing device according to claim 2, wherein the imaging device performs brightness adjustment of the partial area based on brightness of the surroundings.

5. The information processing device according to claim 1, further comprising a detection part configured to detect a gaze area at which the user of the moving image is gazing,
wherein the brightness modification part changes brightness of the gaze area on the moving image based on the gaze area detected by the detection part.

6. The information processing device according to claim 1, further comprising an audio recognition part configured to detect an audio and perform speech recognition,
wherein the brightness modification part adjusts brightness of relating Point of Interest (POI) information in a case in which the audio recognized by the audio recognition part relates to the POI information of the surroundings of the mobile object.

7. The information processing device according to claim 1, further comprising a detection part configured to detect a gaze area at which the user of the moving image is gazing,
wherein the reception part accepts a second operation in a case in which the detection part detects that a partial area of the moving image has been gazed at for a predetermined time or more, and
wherein the brightness modification part changes brightness of the partial area of the moving image based on the second operation accepted by the reception part.

8. The information processing device according to claim 7, wherein the second operation includes a blink, a gesture, and speech.

9. The information processing device according to claim 7, wherein the number of actions included in the second operation is larger than the number of actions included in the first operation.

10. The information processing device according to claim 1, wherein the brightness modification part gives priority for brightness adjustment to the second device that has been connected to the information processing device first among a plurality of second devices.

11. The information processing device according to claim 1, wherein, in a case in which the first operations from a plurality of second devices accepted by the reception part contend with each other, the brightness modification part notifies the plurality of second devices contending with each other of the contention.

12. The information processing device according to claim 1,
wherein, in a case in which the first operations from a plurality of second devices contend with each other, the brightness modification part performs a process of detecting POI information of the surroundings of a partial area of the moving image for which the first operation has been performed by a user of each of the plurality of second devices contending with each other, and
wherein, in a case in which the POI information has been able to be detected, the brightness modification part adjusts brightness of an area in which the POI information has been detected or the POI information.

13. The information processing device according to claim 1,
wherein, in a case in which the first operations from a plurality of second devices accepted by the reception part contend with each other, the brightness modification part performs a process of detecting POI information of the surroundings of a partial area of the moving image for which the first operation has been performed by a user of each of the plurality of second devices contending with each other, and
wherein, in a case in which a plurality of pieces of the POI information have been able to be detected, the brightness modification part notifies the user of each of the plurality of second devices, of which the first operations contend with each other, of an overview of the plurality of pieces of the POI information.

14. An information processing system comprising:
a first device configured to be mounted in a mobile object;
a second device used at a place different from that of the mobile object by a user;
an acquisition part configured to obtain information including moving image data transmitted by the first device;
a provision part configured to provide moving image data for the second device based on the information obtained by the acquisition part;
a reception part configured to accept a first operation performed for a partial area of a moving image presented to the user based on the moving image data provided for the second device by the provision part; and
a brightness modification part configured to change brightness of the partial area of the moving image based on the first operation accepted by the reception part.

15. An information processing method using an information processing device that processes information provided for a second device, which is used at a place different from that of a mobile object by a user, from a first device mounted in the mobile object, the information processing method comprising:
obtaining information including moving image data transmitted by the first device;
providing moving image data for the second device based on the obtained information;
accepting a first operation performed for a partial area of a moving image presented to the user based on the moving image data provided for the second device; and
changing brightness of the partial area of the moving image based on the accepted first operation.
